(19) United States
(12) Patent Application Publication
(10) Pub. No.: US 2026/0115942 A1
(43) Pub. Date: Apr. 30, 2026

(54) FOLDING KNIFE

(71) Applicant: Pi Enterprises, LLC, Moscow, ID (US)

(72) Inventor: Pietro Vittorio Boyd, Moscow, ID (US)

(21) Appl. No.: 19/374,280

(22) Filed: Oct. 30, 2025

Related U.S. Application Data
(60) Provisional application No. 63/713,748, filed on Oct. 30, 2024.

(51) Int. Cl. B26B 1/04; B26B 1/06

(52) U.S. Cl. CPC B26B 1/046; B26B 1/06

(57) ABSTRACT

A folding knife includes a handle, a blade, and a locking assembly. The handle includes a keyhole and the blade includes a through-bore defining a configuration that is complimentary to a configuration of the keyhole. The blade is rotatable relative to the handle from a first, undeployed position to a second, deployed position in a clockwise direction and an opposite counterclockwise direction. The locking assembly includes a pivot receivable within each of the keyhole and the through-bore, a locking ring operably coupled to the pivot, a locking button slidably supported within, and selectively engageable with, each of the pivot and the locking ring, and a biasing element interposed between the locking button and the pivot to bias the locking button towards a first position where the blade is inhibited from rotating relative to the handle.

### CROSS-REFERENCE TO RELATED APPLICATION

This application claims the benefit of, and priority to, U.S. Provisional Patent Application Serial No. 63/713,748, filed on October 30, 2024, the content of which is incorporated by reference herein in its entirety.

### BACKGROUND

### TECHNICAL FIELD

The present disclosure relates to the field of folding knives, and in particular, locking mechanisms for folding knives.

### DESCRIPTION OF RELATED ART

Folding knives enable users to safely store or otherwise carry knives in small locations, such as pockets, small bags, etc. To avoid unintended deployment of the folding knife, locking mechanisms requiring manual input lock the blade of the knife in a closed position, where the blade is inhibited from contacting its surroundings, and an open position, where the blade is fully extended and inhibited from moving relative to the handle to mitigate unintended closing of the knife on a user’s hand or fingers. These locking mechanisms often permit rotation or deployment of the blade only in a single direction, limiting motion of the blade to 180 degrees. Further, the handles employing these locking mechanisms utilize two scales, between which the blade nests when in a closed position. As can be appreciated, knives that are permitted to deploy only in a single direction may require repositioning hardware on the knife to accommodate both left-handed and right handed users, and locking mechanisms utilizing two scales increase complexity, weight, and cost of folding knives.

### SUMMARY

A folding knife includes a handle defining an upper surface and an opposite lower surface, the handle including a keyhole defined through each of the upper surface and the lower surface, a blade defining a top surface and an opposite bottom surface, the blade including a through-bore defined through each of the top surface and the bottom surface, the through-bore defining a configuration that is complimentary to a configuration of the keyhole, wherein the blade is rotatable relative to the handle from a first, undeployed position to a second, deployed position in a clockwise direction and an opposite counterclockwise direction, and a locking assembly, the locking assembly including a pivot receivable within each of the keyhole and the through-bore and rotatably supporting the blade, a locking ring operably coupled to the pivot, wherein each of the handle and the blade are interposed between the pivot and the locking ring, a locking button slidably supported within each of the pivot and the locking ring, the locking button selectively engaging the keyhole and the through-bore, and a biasing element interposed between the locking button and the pivot, the biasing element biasing the locking button towards a first position where the blade is inhibited from rotating relative to the handle.

In aspects, the locking button may define a pair of radially extending tabs, the pair of radially extending tabs engageable with corresponding first keyhole slots defined through the handle and second keyhole slots defined through the blade.

In other aspects, when the blade is disposed in the first, undeployed position, the pair of radially extending tabs may engage each of the first keyhole slots and the second keyhole slots to inhibit rotation of the blade relative to the handle.

In certain aspects, when the locking button is depressed, the pair of radially extending tabs may disengage from the first keyhole slots of the handle, enabling rotation of the blade in a clockwise direction and a counterclockwise direction relative to the handle.

In other aspects, the blade may be rotatable from the second, deployed position to the first, undeployed position in a clockwise direction and an opposite counterclockwise direction.

In certain aspects, the blade may be rotatable 360 degrees relative to the handle.

In aspects, the locking mechanism may be configured to lock the blade relative to the handle at the first, undeployed position, the second, deployed position, and a third position between the first, undeployed position and the second, deployed position.

In other aspects, the locking mechanism may be configured to lock the blade relative to the handle at a fourth position between the first, undeployed position and the second, deployed position.

In aspects, the third position may be in a clockwise position relative to the first, undeployed position.

In certain aspects, the fourth position may be in a counterclockwise position relative to the first, undeployed position.

In another aspect of the disclosure, a folding knife includes a handle, a blade selectively rotatable relative to the handle, and a locking assembly operably coupling the blade to the handle. The locking assembly includes a pivot operably coupled to the handle and rotatably supporting the blade, a locking ring threadably coupled to the pivot and configured to retain the blade to the handle, and a locking button slidably supported within a portion of the pivot. The locking button defines a pair of radially extending tabs, wherein the pair radially extending tabs engage a portion of the handle to inhibit rotation of the handle relative to the pivot. The locking button is transitionable from a first position, where the pair of radially extending tabs engage a portion of each of the handle and the blade to inhibit rotation of the blade relative to the handle to a second position, where the pair of radially extending tabs is disengaged from the blade to permit rotation of the blade relative to the handle from a first, undeployed position to a second, deployed position in a clockwise direction and an opposite, counterclockwise direction.

In aspects, the pivot may define a central aperture configured to slidably receive the locking button.

In other aspects, the pivot may define a pair of spaced apart tabs, wherein a transverse channel is defined between the pair of spaced apart tabs. The transverse channel is configured to slidably receive the pair of radially extending tabs of the locking button and inhibit rotation of the locking button relative to the pivot.

In certain aspects, the handle may define a keyhole configured to receive the pivot and engage the pair of radially extending tabs to inhibit rotation of the handle relative to the pivot.

In other aspects, the blade may define a through-bore configured to selectively engage the pair of radially extending tabs to selectively inhibit and permit rotation of the blade relative to the handle from the first, undeployed position to the second, deployed position in a clockwise direction and an opposite, counterclockwise direction.

In another aspect of the disclosure, a locking assembly for a folding knife includes a pivot defining a central lumen and a transverse channel, the transverse channel extending through the central lumen, a locking ring operably coupled to the pivot, a locking button slidably supported within each of the central lumen of the pivot and the locking ring, the locking button defining a pair of radially extending tabs selectively engageable with a blade of the folding knife, wherein the pair of radially extending tabs is slidably receivable within the transverse channel to inhibit rotation of the locking button relative to the pivot, and a biasing element interposed between the locking button and the pivot, the biasing element biasing the locking button towards a first position where the pair of radially extending tabs engage the blade of the folding knife and inhibit the blade from rotating relative to the pivot.

In certain aspects, the pivot may define a pair of tabs disposed in spaced relation to define the transverse channel.

In aspects, the locking ring may define a threaded bore configured to receive at least a portion of the pair of tabs of the pivot.

In other aspects, external threads may be defined about a circumference of the pair of tabs, wherein the external threads are threadably engageable with the threaded bore of the pivot to operably couple the locking ring to the pivot.

In aspects, a hole may be defined within the locking button, the hole configured to retain at least a portion of the biasing element.

### BRIEF DESCRIPTION OF THE DRAWINGS

Various aspects and embodiments of the disclosure are described hereinbelow with references to the drawings, wherein:

FIG. 1 is an exploded, top perspective view of a folding knife in accordance with the disclosure;

FIG. 2 is an exploded view of a locking assembly of the folding knife of FIG. 1;

FIG. 3 is an exploded, bottom perspective view of the folding knife of FIG. 1;

FIG. 4 is a side, cross-sectional view of the folding knife of FIG. 1, shown in an undeployed position;

FIG. 5 is a top view of the folding knife of FIG. 1, shown in the undeployed position;

FIG. 6 is a bottom view of the folding knife of FIG. 1, shown in the undeployed position;

FIG. 7 is a side, cross-sectional view of the folding knife of FIG. 1, shown in a deployed position;

FIG. 8 is a top view of the folding knife of FIG. 1, shown in the deployed position; and

FIG. 9 is a bottom view of the folding knife of FIG. 1, shown in the deployed position.

### DETAILED DESCRIPTION

The disclosure is directed to a folding knife having a blade that is deployable 180 degrees in a clockwise and a counterclockwise direction relative to a handle (e.g., the blade 40 is rotatable 360 degrees relative to the handle 12). The folding knife includes a handle having a single scale and a locking assembly operably coupling, and selectively locking, the blade to the handle. The locking assembly includes a pivot rotatably supporting the blade on the handle, a thrust washer or bushing interposed between the blade and the handle, a locking ring operably coupled to the pivot to selectively couple the handle to the blade, a locking button slidably supported within a portion of each of the pivot, the blade, the handle, and the locking ring, and a biasing element interposed between the pivot and the locking ring. The biasing element biases the locking button towards the locking ring, where the locking button engages corresponding features defined within the handle and the blade to inhibit movement of the blade relative to the handle. In embodiments, the features defined within the handle and the blade selectively engage the locking button when the blade is in an undeployed position and when the blade is in a deployed position. In this manner, when the locking button is depressed, the blade may be urged or otherwise rotated in both directions (e.g., clockwise and counterclockwise) relative to the handle when transitioning from the undeployed position to the deployed position and vice versa, as opposed to being limited to movement only in a single direction.

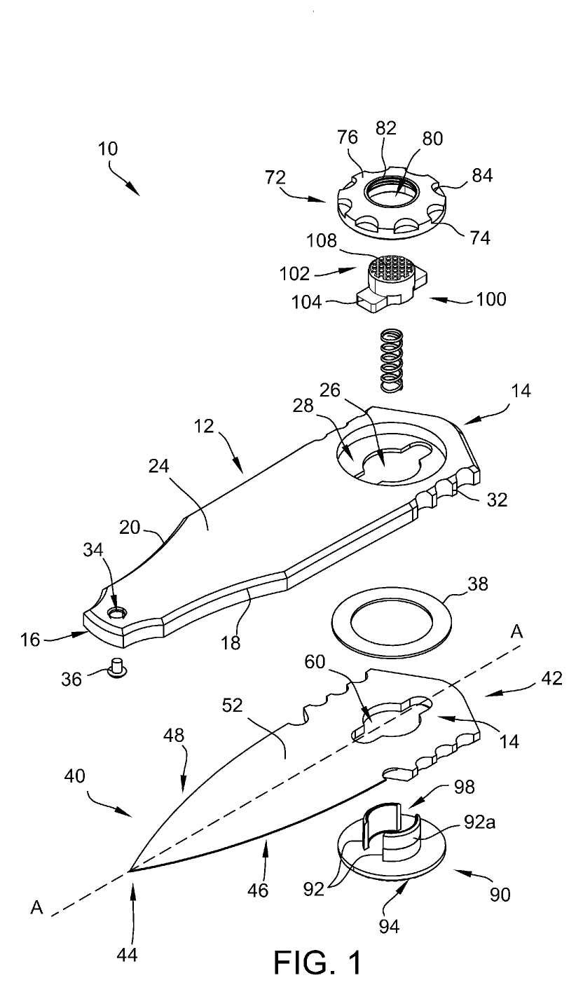

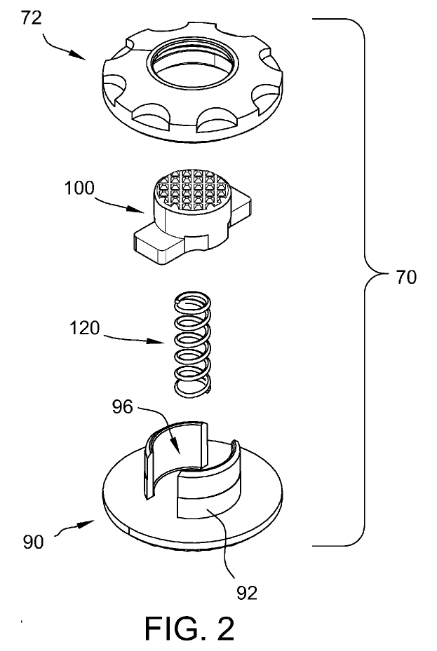

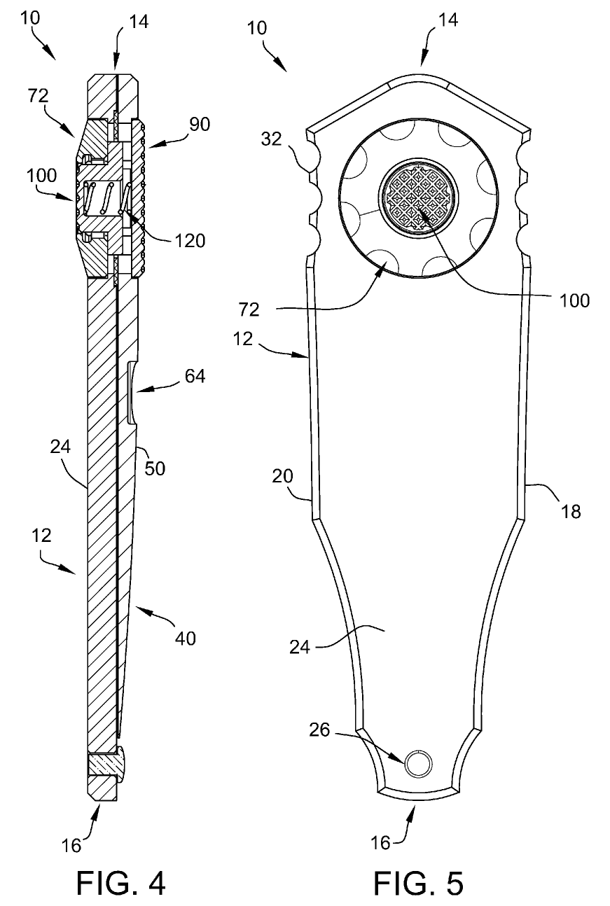

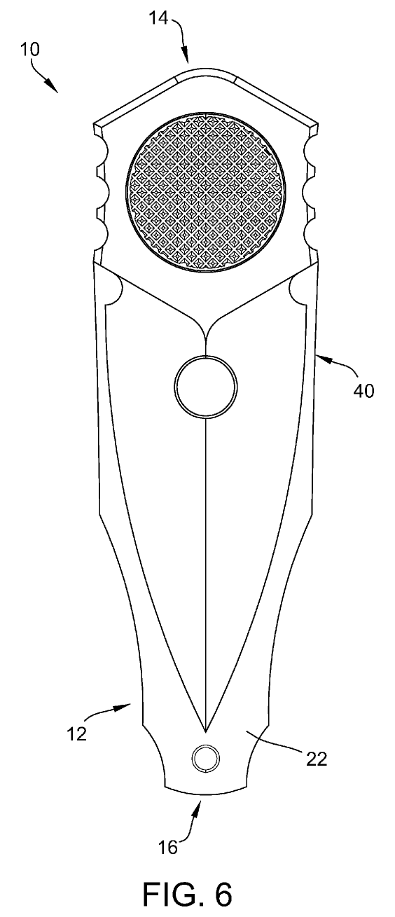

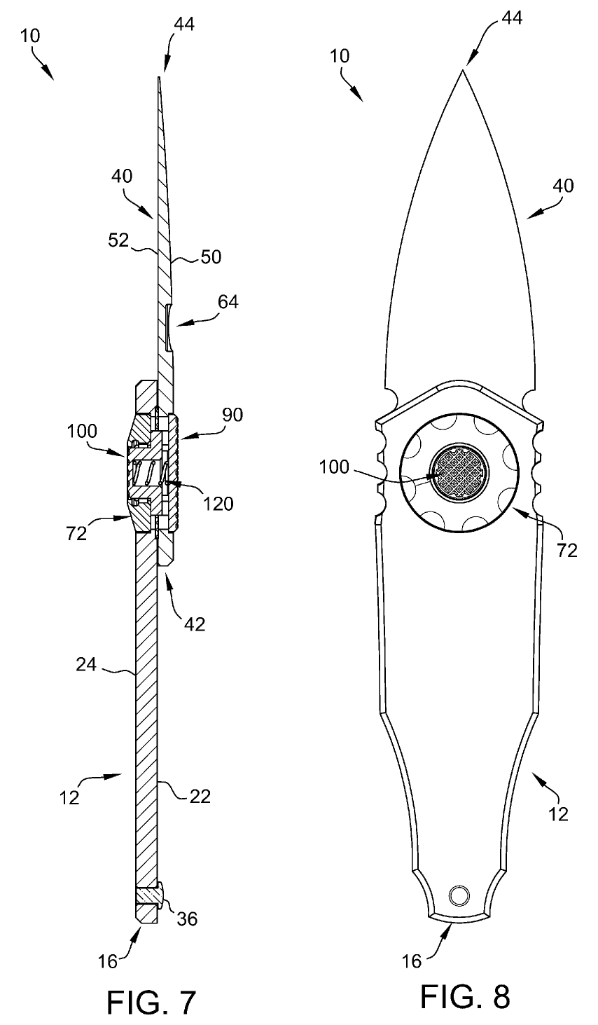

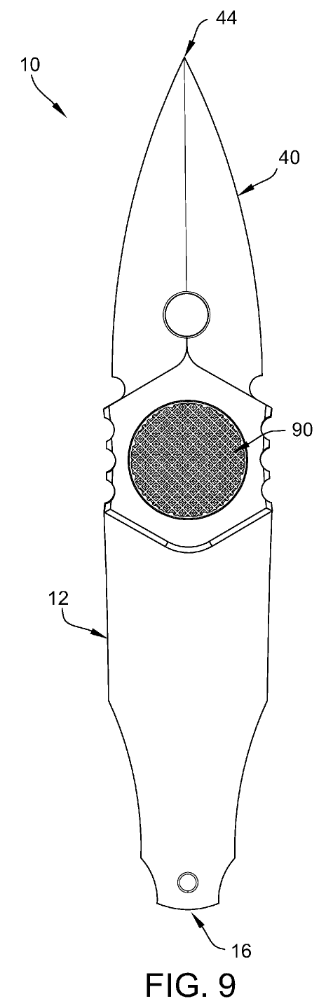

Turning now to the drawings, FIGS. 1 and 2 illustrate a folding knife in accordance with the disclosure and generally identified by reference numeral 10. The folding knife 10 includes an elongate handle 12 and a blade 40 that is rotatably coupled to the handle 12. The blade 40 is rotatably coupled to the handle 12 by a locking assembly 70 which is selectively actuatable to lock the blade 40 in a first, undeployed position (FIGS. 4-6) and a second, deployed position (FIG. 7-9). In some embodiments, the locking mechanism 70 is selectively actuatable to lock the blade 40 in any number of positions relative to the first, undeployed position.

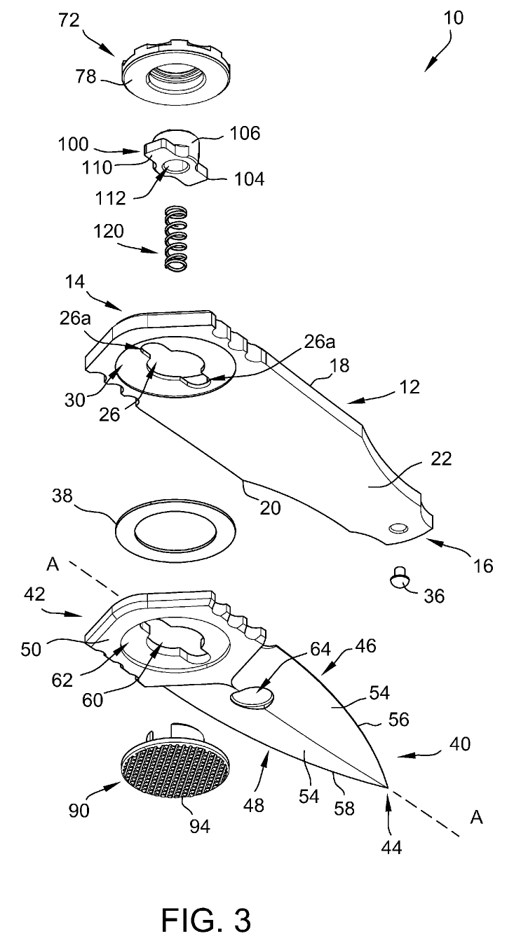

With additional reference to FIGS. 3-9, the elongate handle 12 extends between a front or forward end portion 14 and an opposite rear or butt end portion 16. The handle 12 defines first side portion 18 and a second, opposite side portion 20, each extending between the front end portion 14 and the butt end portion 16. The handle 12 defines an upper surface 22 (FIG. 3) and an opposite, lower surface 24 (FIG. 1), each extending between the front end portion 14, the butt end portion 16, the first side portion 18, and the second side portion 20. As can be appreciated, the handle 12 includes outer dimensions that are greater than or generally equal to the outer dimension of the blade 40 to inhibit outside contact with a point 44 and/or sharpened edges 56, 58. A through-hole or keyhole 26 is defined through each of the upper surface 22 and the lower surface 24 and is disposed adjacent to the front end portion 14. The keyhole 26 defines a generally butterfly profile having a central bore and opposed keyway slots 26a. Although generally illustrated as extending longitudinally along the handle 12, it is envisioned that the opposed keyway slots 26a may extend in any direction relative to a longitudinal axis of the handle 12, such as transverse, diagonal, etc. In embodiments, the keyhole 26 may include any number of keyway slots 26b without departing from the scope of the disclosure, such as one, three, four, etc. As will be described in further detail hereinbelow, the keyhole 26 is selectively engageable by the locking assembly 70 to selectively lock the blade 12 in the first, undeployed position or the second, deployed position, and any number of positions between the first, undeployed position and the second, deployed position (e.g., between 0 and 180 degrees and between 180 and 360 degrees). Although generally described as defining a keyhole shape, the through-hole define any suitable engagement feature, such as detents, radial slots, through-holes, resilient fingers, etc., and combinations thereof, without departing from the scope of the disclosure.

In one non-limiting embodiment, a plurality of holes (not shown) is defined within the lower surface 24 of the handle 12 and arranged circumferentially about the through-hole 26. The plurality of holes is configured to receive one or more pins (not shown) of the locking assembly 70 to selectively lock the blade 40 relative to the handle 12 at various rotational positions relative to the handle 12. In this manner, the holes of the plurality of holes are arranged at intervals circumferentially about the through-hole 26, such that the blade 40 may be selectively locked at various positions relative to the handle 12 when rotated relative to the handle 12, which in embodiments, may be the first, undeployed position and the second, deployed position. In some embodiments, pairs of holes of the plurality of holes may be 180 degrees offset such that a corresponding pair of pins (not shown) of the locking assembly 70 may be received within respective holes to lock the blade 40 relative to the handle 12 in the corresponding position, although any number of holes, or any pattern of holes may be engaged by any number of corresponding pins without departing from the scope of the disclosure.

In some embodiments, in lieu of or in addition to, the keyway slots 26b, the handle 12 may include one or more splines (not shown) defined through the lower surface 24 of the handle 12 and arranged about the through-hole 26. In some embodiments, the one or more splines may protrude from the lower surface 24. In one non-limiting embodiment, one or more of the splines may protrude from the lower surface 24 and one or more other splines may be formed through the lower surface 24. The one or more splines are circumferentially arranged about the through-hole 26 such that the blade 40 may be selectively locked at various positions relative to the handle 123 when rotated relative to the handle, which in embodiments, may be the first, undeployed position and the second, deployed position. The one or more splines are configured to selectively engage corresponding splines of the locking assembly 70, as will be described in further detail hereinbelow. In some embodiments, the one or more splines may be defined on an inner circumference of the through-hole and/or extend through one or both of the upper surface 22 and the lower surface 24.

A first counterbore 28 is defined through the lower surface 24 and is disposed coaxial with or generally aligned with the keyhole 26. As will be described in further detail hereinbelow, the keyhole 26 receives a portion of the pivot 90 of the locking assembly 70 and the first counterbore 28 receives a portion of a locking ring 72 of the locking assembly 70 to selectively couple the blade 40 to the handle 12. A second counterbore 30 (FIG. 3) is defined through the upper surface 22 and is disposed coaxial with or generally aligned with the keyhole 26 and/or the first counterbore 28. The second counterbore 30 receives a portion of a washer or bushing 38 to capture or otherwise maintain alignment of the bushing 38 relative to the handle 12 and the blade 40.

In embodiments, a portion of the one or both of the first side portion 18 and the second side portion 20 of the handle 12 defines a plurality of crenellations or jimping 32 adjacent to the front end portion 14. As can be appreciated, the jimping 32 is engageable by a user’s hand and aids or otherwise increases the user’s grip on the handle 12 as compared to a handle without the jimping 32. Although generally illustrated with the jimping 32 formed on each of the first side portion 18 and the second side portion 20, it is envisioned that only one of the first side portion 18 and second side portion 20 may include jimping 32 or the handle 12 may not include jimping 32, depending upon the design needs of the handle 12. It is contemplated that the handle 12 may include a bore 34 defined through each of the upper surface 22 and the lower surface 24 adjacent to the base butt portion 16. The bore 34 may be threaded for threadable engagement with a fastener 36 or may be unthreaded.

It is envisioned that the handle 12 may be formed from a single component or may be formed from more than one component. For example, the handle 12 may include a liner (not shown) operably coupled to one or more scales (not shown), which may be formed from the same or different material as the one or more scales. In this manner, the liner may be made from a material that is harder or otherwise more resistant to wear as compared to the one or more scales.

With continued reference to FIGS. 1-9, the blade 40 defines a generally spear point profile defining a longitudinal axis A-A extending between a tang end 42 and an opposite point 44. Although generally illustrated as having a spear point profile, it is envisioned that the blade 40 may include any suitable profile without departing from the scope of the disclosure. The blade 40 defines a first side portion 46 and a second, opposite side portion 48, each extending between the tang end 42 and the point 44. The first side portion 46 and the second side portion 48 increasingly approximate one another along the longitudinal axis A-A in a direction extending towards the point 44. In this manner, the first side portion 46 intersects the second side portion 48 to define the sharpened point 44.

The blade 40 defines a top surface 50 (FIG. 3) and an opposite, bottom surface 52, each extending between the tang end 42, the point 44, the first side portion 46, and the second side portion 48. The top surface 50 defines one or more bevels 54 extending from an inner portion of the blade 40 towards each of the first side portion 46 and the second side portion 48. The one or more bevels 54 intersect the bottom surface 52 and define a first sharpened edge 56 on the first side portion 46 and a second sharpened edge 58 on the second side portion 48. Although generally illustrated as extending partially along the length of each of the first side portion 46 and the second side portion 48, it is envisioned that the one or more bevels 54 may extend any length along the first side portion 46 and the second side portion 48 and may extend different amounts along the first and second side portions 46, 48 without departing from the scope of the disclosure. In embodiments, the top surface 50 may define only one bevel 54.

A through-bore 60 is defined through each of the top surface 50 and the bottom surface 52 adjacent to the tang end 42 of the blade 40. The through-bore 60 defines a profile that is generally complementary to the profile of the keyhole 26 of the handle 12 and includes a pair of keyway slots 60a (FIG. 1), although it is envisioned that the through-bore 60 may include any suitable profile or any suitable locking features without departing from the scope of the disclosure. As will be described in further detail hereinbelow, the through-bore 60 receives a portion of a pivot 90 of the locking assembly 70 to rotatably couple the blade 40 to the handle 12. A counterbore 62 is defined through the top surface 50 of the blade 40 and is coaxially with or generally aligned with the through-bore 60. The counterbore 62 receives a head or flange 94 of the locking assembly 70 to locate or otherwise align the blade 40 with the handle 12.

In one non-limiting embodiment, a dimple or similar feature 64 (FIG. 3) is defined through the top surface 50 of the blade 40. The dimple 64 is generally aligned with the longitudinal axis A-A and disposed at a general midportion of the blade 40, although it is contemplated that the dimple 64 may be disposed at any suitable location on the top surface 50 and may include any suitable profile, which in embodiments, may be a protuberance. The dimple 64 may include an engraving or other decorative element (not shown) and/or may be selectively engageable by a user to aid or otherwise enable the user to urge the blade 40 from the first, undeployed position to the second, deployed position and vice versa. It is envisioned that the blade 40 may not include a dimple 64 or may include any other suitable feature that is engageable to assist with urging the blade 40 from the first, undeployed position to the second, deployed position, and vice versa. Although generally illustrated as including jimping, it is envisioned that the blade 40 may not include jimping or the jimping may be defined on only one of the first side portion 46 or the second side portion 48.

With continued reference to FIGS. 1-9, the locking assembly 70 includes a locking ring 72, a pivot 90, a locking button 100, and a biasing element 120. The locking ring 72 defines a generally circular profile defining an outer surface 74 extending between a top portion 76 and an opposite bottom portion 78 (FIG. 3) and is generally complimentary to the profile of the first counterbore 28 of the handle 12. In this manner, the locking ring 72 is received within or otherwise is disposed in a nested configuration with the first counterbore 28 of the handle 12 to location or otherwise inhibit lateral movement of the locking ring 72 relative to the handle 12. A bore 80 is defined through each of the top portion 76 and the bottom portion 78, which in embodiments, may define internal threads 82. The internal threads 82 threadably engage corresponding external threads 92a defined on the pivot 90 to selectively couple the locking ring 72 to the pivot 90 and retain the blade 40 to the handle 12. Although generally described as including internal threads 82, it is envisioned that the locking ring 72 may be selectively coupled to the pivot 90 using any suitable means, such as a snap fit, a press fit, a friction fit, detents, etc., and combinations thereof. In embodiments, a plurality of crenellations 84 may be defined within the top portion 76 of the locking ring 72 to aid a user when grasping and/or manipulating the locking ring 72.

The pivot 90 defines a generally t-shaped profile having a pair of tabs 92 extending from a radial flange or head 94. The head 94 defines a circular profile that is generally complimentary to the counterbore, although it is envisioned that the head 94 may include any suitable profile without departing from the scope of the disclosure. The head 94 is sized and dimensioned for receipt within the counterbore 62 of the blade 40 to retain or otherwise inhibit lateral movement of the pivot 90 relative to the blade 40. The pair of tabs 92 are disposed in spaced relation to each other and defines a central lumen 96 (FIG. 2) for slidably receiving a portion of the locking button 100. A transverse channel 98 is defined between the pair of tabs for slidably receiving the pair of radial tabs 104 of the locking button 100. The pair of tabs 92 are selectively or otherwise threadably engageable with the bore 80 of the locking ring 72. It is envisioned that one or both of the pair of tabs 92 may be formed from a resilient material and may be selectively deformable to deform when being advanced within the bore 80 of the locking ring 72 and return to an original, undeformed state when received within the bore 80. In embodiments, the pair of tabs 92 may define external threads 92a for threadable engagement with the internal threads 82 of the locking ring 72 to selectively couple the pivot 90 to the locking ring 72. In this manner, the locking ring 72 and the pivot 90 cooperate to prevent or otherwise inhibit radial movement of the blade 40 relative to the handle 12 and enable the blade 40 to pivot relative to the handle 12 about the locking ring 72 and the pivot 90.

The locking button 100 defines a generally T-shaped profile having a center button 102 and a pair of radially extending tabs 104. Although generally illustrated as having a pair of radially extending tabs 104, the locking button may include any suitable feature or combination of features that engage with or otherwise interact with the locking features of the handle and/or the blade without departing from the scope of the disclosure. The center button 102 defines an outer surface 106 extending between an upper surface 108 and an opposite lower surface 110 (FIG. 3). The outer dimension of the outer surface 106 is generally complimentary to an inner dimension of the bore 80 of the locking ring and the central lumen 96 of the pivot 90 and the pair of radially extending tabs 104 are slidably receivable within the transverse channel 98 of the pivot 90. In this manner, the locking button 100 is slidably retained within the central lumen 96 and transverse channel 98 of the pivot 90 along a central axis of the pivot 90. The pair of radially extending tabs 104 selectively engage the pair of opposed keyway slots 26a of the keyhole 26 to selectively lock and unlock a position of the blade 40 relative to the handle 12. A hole 112 (FIG. 3) is defined through the lower surface 110 for receipt of the biasing element 120. Although generally illustrated as a blind hole, it is envisioned that the hole 112 may be a through-hole or extend partially through the upper surface 108. In this manner, the biasing element is interposed between the pivot 90 and the locking button 100 to bias the locking button 100 in a direction extending away from the pivot 90. Although generally illustrated as being a coil spring, it is envisioned that the biasing element 120 may be any suitable biasing element without departing from the scope of the disclosure.

In embodiments where the handle 12 includes a plurality of holes defined through the lower surface 24, the locking button 100 may define one or more pins and/or protrusions (not shown) that are configured to be selectively received within a corresponding hole of the plurality of holes to lock the blade 40 relative to the handle 12. In some embodiments, the one or more pins and/or protrusions may define a generally uniform shape extending in a direction away from the locking button 100 or may define a tapered shape extending in a direction away from the locking button 100 (e.g., an outer dimension of the pin and/or protrusion decreases in a direction extending away from the locking button 100).

In embodiments where the handle 12 includes one or more splines defined on and/or through the lower surface 24, the locking button 100 may define one or more splines (not shown) configured to selectively engage a corresponding one or more splines of the handle 12. In some embodiments, the one or more splines may define a generally trapezoidal profile, where an upper portion of the spline includes a width that is less than a width of a lower portion of the spline. In one non-limiting embodiment, one or more splines (not shown) may be defined on an outer surface of one or both of the pair of radially extending tabs 104 to reduce slop of the blade relative to the handle.

It is envisioned that the handle 12, the blade 40, the locking ring 72, the pivot 90, and the locking button 100 may be formed from any suitable material depending upon the design needs of the folding knife 10. In some embodiments, the folding knife 10 may include an automatic opening or assisted opening mechanism that is operable to automatically transition, or assist with transitioning, the blade 40 from the first, undeployed position to the second, deployed position in only one or a counterclockwise or a clockwise direction, or either one of the counterclockwise or the clockwise direction, as described herein. The locking mechanisms described herein are not limited to locking the blade 40 in two positions relative to the handle 12. For example, the locking mechanisms described herein may lock the blade 40 in any position, and any number of positions, relative to the handle 12 in both the clockwise and counterclockwise direction (e.g., between 0 and 360 degrees). In one non-limiting embodiment, the locking mechanisms described herein locks the blade 40 at a third position that is between the first, undeployed position and the second, deployed position in a clockwise direction and locks the blade 40 at a fourth position that is between first, undeployed position and the second, deployed position in a counterclockwise direction.

In operation, when in the first, undeployed configuration (FIGS. 4-6), the pair of radially extending tabs 104 of the locking button 100 is received within the opposed keyway slots 26a of the handle 12 and the opposed keyway slots 60a of the blade 40 to lock or otherwise inhibit rotation of the blade 40 relative to the handle 12. In the first, undeployed configuration, the point 44 of the blade 40 is disposed over the handle 12 and adjacent to the butt end 16. In this manner, the point 44 and the sharpened edges 56, 58 of the blade 40 are guarded by the first and second side portions 18, 20 to inhibit unwanted contact with the point 44 and/or the sharpened edges 56, 58. The biasing element 120 biases the locking button 100 towards the locking ring 72 to place or otherwise orient the pair of radially extending tabs 104 with the opposed keyway slots 26a, 60a of the handle 12 and blade 40. In the first, undeployed position, the pair of radially extending tabs 104 engage or otherwise interlock with the opposed keyway slots 26a, 60a to maintain the blade in an undeployed position relative to the handle 12. As can be appreciated, the above described operation may be employed in embodiments where the handle 12 includes a plurality of holes that engage one or more pins on the locking button 100 and/or embodiments where the handle 12 and the locking button 100 include one or more splines.

To transition the blade 40 to the second, deployed configuration (FIGS. 7-9), the locking button 100 is depressed or otherwise urged in a direction extending towards the pivot 90 to compress the biasing element 120. Continued movement of the locking button 100 towards the pivot 90 disengages the pair of radially extending tabs 104 from the opposed keyway slots 26a of the handle 12, enabling the blade 40 to rotate relative to the handle 12 in either a clockwise direction or a counterclockwise direction (e.g., the blade 40 is rotatable 360 degrees relative to the handle 12). Once rotation of the blade 40 relative to the handle 12 has begun, the locking button 100 may be released. With the blade 40 in the fully deployed position, the pair of radially extending tabs 104 will be aligned with the opposed keyway slots 26a of the handle 12 and the biasing element 120 will urge or otherwise cause the pair of radially extending tabs 104 to engage or otherwise be received in the opposed keyway slots 26a of the handle 12 to lock the blade 40 in the second, deployed configuration. In embodiments, where the blade 40 is selectively lockable at positions between 0 and 180 degrees (in a clockwise direction and a counterclockwise direction), the procedure described above may be repeated any number of times as needed to transition the blade 40 to a desired position relative to the handle. As can be appreciated, the above described operation may be employed in embodiments where the handle 12 includes a plurality of holes that engage one or more pins on the locking button 100 and/or embodiments where the handle 12 and the locking button 100 include one or more splines.

To transition the blade 40 back to the first, undeployed position, the locking button 100 is once again depressed to disengage the pair of radially extending tabs 104 from the opposed keyway slots 26a, and the blade 40 may be rotated in either a clockwise direction or a counterclockwise direction (e.g., the blade 40 is rotatable 360 degrees relative to the handle 12). As can be appreciated, the above described operation may be employed in embodiments where the handle 12 includes a plurality of holes that engage one or more pins on the locking button 100 and/or embodiments where the handle 12 and the locking button 100 include one or more splines.

This written description uses examples to illustrate the present disclosure, including the best mode, and also to enable any person skilled in the art to practice the disclosure, including making and using any compositions or systems and performing any incorporated methods. The patentable scope of the disclosure is defined by the claims, and may include other examples that occur to those skilled in the art. Such other examples are intended to be within the scope of the claims if they have elements that do not differ from the literal language of the claims, or if they include equivalent elements with insubstantial differences from the literal language of the claims.

As used herein, the terms “comprises,” “comprising,” “includes,” “including,” “has,” “having,” “contains,” “containing,” “characterized by” or any other variation thereof, are intended to cover a non-exclusive inclusion, subject to any limitation explicitly indicated. For example, a composition, mixture, process or method that comprises a list of elements is not necessarily limited to only those elements but may include other elements not expressly listed or inherent to such composition, mixture, process or method.

The transitional phrase “consisting of” excludes any element, step, or ingredient not specified. If in the claim, such would close the claim to the inclusion of materials other than those recited except for impurities ordinarily associated therewith. When the phrase “consisting of” appears in a clause of the body of a claim, rather than immediately following the preamble, it limits only the element set forth in that clause; other elements are not excluded from the claim as a whole.

The transitional phrase “consisting essentially of” is used to define a composition or method that includes materials, steps, features, components, or elements, in addition to those literally disclosed, provided that these additional materials, steps, features, components, or elements do not materially affect the basic and novel characteristic(s) of the claimed invention. The term “consisting essentially of” occupies a middle ground between “comprising” and “consisting of.”

Where an invention or a portion thereof is defined with an open-ended term such as “comprising,” it should be readily understood that (unless otherwise stated) the description should be interpreted to also describe such an invention using the terms “consisting essentially of” or “consisting of.”

Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

Also, the indefinite articles “a” and “an” preceding an element or component of the invention are intended to be nonrestrictive regarding the number of instances (i.e., occurrences) of the element or component. Therefore, “a” or “an” should be read to include one or at least one, and the singular word form of the element or component also includes the plural unless the number is obviously meant to be singular.

As used herein, the term “about” means plus or minus 10% of the value.

What is claimed is:

1. A folding knife, comprising:
a handle defining an upper surface and an opposite lower surface, the handle including a keyhole defined through each of the upper surface and the lower surface;
a blade defining a top surface and an opposite bottom surface, the blade including a through-bore defined through each of the top surface and the bottom surface, the through-bore defining a configuration that is complimentary to a configuration of the keyhole, wherein the blade is rotatable relative to the handle from a first, undeployed position to a second, deployed position in a clockwise direction and an opposite counterclockwise direction; and
a locking assembly, the locking assembly including:
a pivot receivable within each of the keyhole and the through-bore and rotatably supporting the blade;
a locking ring operably coupled to the pivot, wherein each of the handle and the blade are interposed between the pivot and the locking ring;
a locking button slidably supported within each of the pivot and the locking ring, the locking button selectively engaging the keyhole and the through-bore; and
a biasing element interposed between the locking button and the pivot, the biasing element biasing the locking button towards a first position where the blade is inhibited from rotating relative to the handle.

2. The folding knife according to claim 1, wherein the locking button defines a pair of radially extending tabs, the pair of radially extending tabs engageable with corresponding first keyhole slots defined through the handle and second keyhole slots defined through the blade.

3. The folding knife according to claim 2, wherein when the blade is disposed in the first, undeployed position, the pair of radially extending tabs engage each of the first keyhole slots and the second keyhole slots to inhibit rotation of the blade relative to the handle.

4. The folding knife according to claim 2, wherein when the locking button is depressed, the pair of radially extending tabs is disengaged from the first keyhole slots of the handle, enabling rotation of the blade in a clockwise direction and a counterclockwise direction relative to the handle.

5. The folding knife according to claim 1, wherein the blade is rotatable from the second, deployed position to the first, undeployed position in a clockwise direction and an opposite counterclockwise direction.

6. The folding knife according to claim 1, wherein the blade is rotatable 360 degrees relative to the handle.

7. The folding knife according to claim 1, wherein the locking mechanism is configured to lock the blade relative to the handle at the first, undeployed position, the second, deployed position, and a third position between the first, undeployed position and the second, deployed position.

8. The folding knife according to claim 7, wherein the locking mechanism is configured to lock the blade relative to the handle at a fourth position between the first, undeployed position and the second, deployed position.

9. The folding knife according to claim 8, wherein the third position is in a clockwise position relative to the first, undeployed position.

10. The folding knife according to claim 9, wherein the fourth position is in a counterclockwise position relative to the first, undeployed position.

11. A folding knife, comprising:
a handle;
a blade selectively rotatable relative to the handle; and
a locking assembly operably coupling the blade to the handle, the locking assembly comprising:
a pivot operably coupled to the handle and rotatably supporting the blade;
a locking ring threadably coupled to the pivot and configured to retain the blade to the handle; and
a locking button slidably supported within a portion of the pivot, wherein the locking button defines a pair of radially extending tabs, wherein the pair of radially extending tabs engage a portion of the handle to inhibit rotation of the handle relative to the pivot, wherein the locking button is transitionable from a first position, where the pair of radially extending tabs engage a portion of each of the handle and the blade to inhibit rotation of the blade relative to the handle to a second position, where the pair of radially extending tabs is disengaged from the blade to permit rotation of the blade relative to the handle from a first, undeployed position to a second, deployed position in a clockwise direction and an opposite, counterclockwise direction.

12. The folding knife according to claim 11, wherein the pivot defines a central aperture configured to slidably receive the locking button.

13. The folding knife according to claim 12, wherein the pivot defines a pair of spaced apart tabs, wherein a transverse channel is defined between the pair of spaced apart tabs, the transverse channel configured to slidably receive the pair of radially extending tabs of the locking button and inhibit rotation of the locking button relative to the pivot.

14. The folding knife according to claim 13, wherein the handle defines a keyhole configured to receive the pivot and engage the pair of radially extending tabs to inhibit rotation of the handle relative to the pivot.

15. The folding knife according to claim 14, wherein the blade defines a through-bore configured to selectively engage the pair of radially extending tabs to selectively inhibit and permit rotation of the blade relative to the handle from the first, undeployed position to the second, deployed position in a clockwise direction and an opposite, counterclockwise direction.

16. A locking assembly for a folding knife, the locking assembly comprising:
a pivot defining a central lumen and a transverse channel, the transverse channel extending through the central lumen;
a locking ring operably coupled to the pivot;
a locking button slidably supported within each of the central lumen of the pivot and the locking ring, the locking button defining a pair of radially extending tabs selectively engageable with a blade of the folding knife, wherein the pair of radially extending tabs is slidably receivable within the transverse channel to inhibit rotation of the locking button relative to the pivot; and
a biasing element interposed between the locking button and the pivot, the biasing element biasing the locking button towards a first position where the pair of radially extending tabs engage the blade of the folding knife and inhibit the blade from rotating relative to the pivot.

17. The locking assembly according to claim 16, wherein the pivot defines a pair of tabs disposed in spaced relation to define the transverse channel.

18. The locking assembly according to claim 17, wherein the locking ring defines a threaded bore configured to receive at least a portion of the pair of tabs of the pivot.

19. The locking assembly according to claim 18, wherein external threads are defined about a circumference of the pair of tabs, where the external threads are threadably engageable with the threaded bore of the pivot to operably couple the locking ring to the pivot.

20. The locking assembly according to claim 16, wherein a hole is defined within the locking button, the hole configured to retain at least a portion of the biasing element.
